(19) United States
(12) Patent Application Publication
(10) Pub. No.: US 2011/0286370 A1
(43) Pub. Date: Nov. 24, 2011

(54) UTILIZATION METHOD AND APPARATUS FOR GUARD BAND

(75) Inventors: Hai Tang, Beijing (CN); Nan Li, Beijing (CN); Haitao Jiang, Beijing (CN)

(73) Assignee: China Mobile Communications Corporation, Beijing (CN)

(21) Appl. No.: 13/143,690

(22) PCT Filed: Jan. 8, 2010
(86) PCT No.: PCT/CN2010/000035

§ 371 Date: Aug. 12, 2011

(30) Foreign Application Priority Data
Jan. 8, 2009 (CN) 200910076542.6

(51) Int. Cl. H04J 3/02

(52) U.S. Cl. 370/280

(57) ABSTRACT

A utilization method and apparatus for guard band, used under the premise that side-channel interference is suppressed when a time division duplex (TDD) system and a frequency division duplex (FDD) system coexist, utilizes guard band effectively and increases utilization rate of mobile communication spectrum resources. The utilization method for guard band comprises: a first base station in a TDD system allocates a first frequency resource within an uplink guard band to a first user equipment and issues resource scheduling information (S1001); the first base station receives the uplink data carried in uplink time units on the first frequency resource, which is sent by the first user equipment according to the resource scheduling information (S 1002); the first base station carries the downlink data in downlink time units and sends the downlink data to the first user equipment on a second frequency resource, the second frequency resource comprises frequency resource in a downlink guard band and/or frequency resource in a TDD band (S1003).

This application claims priority to Chinese Patent Application No. 200910076542.6, filed with the State Intellectual Property Office of the People's Republic of China on Jan. 8, 2009 and entitled “Method and device for utilizing guard bands”, which is hereby incorporated by reference in its entirety.

### FIELD OF INVENTION

The present invention relates to the field of mobile communications and particularly to a technology for utilizing guard bands.

### BACKGROUND OF THE INVENTION

Two modes of Time Division Duplex (TDD) and Frequency Division Duplex (FDD) are adopted to implement a radio interface for a terrestrial radio access to a Universal Mobile Telecommunication System (UMTS).

The TDD mode is a duplex mode in which both uplink and downlink data is transmitted over the same frequency resource (i.e., carrier), time-varying switching of uplink and downlink transmission has to be performed, temporal units at the physical layer are divided into uplink and downlink temporal units and include Time Slots (TS) and Orthogonal Frequency Division Multiplexing (OFDM) symbols in an OFDM system. The FDD mode is a duplex mode in which uplink and downlink data is transmitted over two corresponding separate frequency resources and there is typically a spacing of 190 MHz between uplink and downlink frequencies

Three Radio Transmission Technology (RTT) standards based upon the technology of Code Division Multiplex Access (CDMA), i.e., Direct Sequence-CDMA (DS-CDMA), Multi-Carrier CDMA (MC-CDMA) and Time Division-CDMA (TD-CDMA), are predominant technologies for a 3^{rd} generation (3G) mobile communication system. The FDD mode is adopted for DS-CDMA and MC-CDMA, and the TDD mode is adopted for TD-CDMA. The International Telecommunication Union-Radio Communications Sector (ITU-R) allocates separate frequency ranges to the FDD and TDD modes, and a TDD system and an FDD system coexist in a 3G network along with deployment of the 3G network. Coexistence of the TDD system and the FDD system is also seen in a Long Time Evolution (LTE) system and a subsequent 4^{th} generation (4G) mobile communication system.

In view of coexistence of the TDD and FDD systems, the authority reserves guard bands between frequency ranges of the TDD system and the FDD system for projection of frequency spectrum resources. FIG. 1 illustrates a schematic diagram of guard bands. The guard bands are configured to suppress adjacent channel interference between the TDD system and the FDD system and therefore are disallowed for transmission of data. As well known, the frequency resources are very limited and non-renewable, and the reserved guard bands are undoubtedly a significant waste of the limited frequency resources, thus resulting in a low utilization ratio of the frequency spectrum resources for mobile communication

### SUMMARY OF THE INVENTION

The invention provides a method and device for utilizing guard bands to effectively utilize guard bands while suppressing adjacent channel interference upon coexistence of a TDD system and an FDD system to thereby improve the utilization ratio of frequency spectrum resources for mobile communication.

The invention provides a first method for utilizing guard bands, which includes:

allocating, by a first base station in a Time Division Duplex, TDD, system, a first frequency resource in an uplink guard band to a first user equipment and issuing resource schedule information, the uplink guard band being a guard band between a Frequency Division Duplex, FDD, uplink frequency range and a TDD frequency range;

receiving, by the first base station, uplink data that the first user equipment bears in an uplink temporal unit and transmits over the first frequency resource according to the resource schedule information; and

bearing, by the first base station, downlink data in a downlink temporal unit and transmitting the downlink data to the first user equipment over a second frequency resource including a frequency resource in a downlink guard band and/or a frequency resource in the TDD frequency range, the downlink guard band being a guard band between an FDD downlink frequency range and the TDD frequency range

Correspondingly, the invention provides a base station including:

a resource scheduling unit configured to allocate a first frequency resource in an uplink guard band to a user equipment and issue resource schedule information, the uplink guard band being a guard band between a Frequency Division Duplex, FDD, uplink frequency range and a TDD frequency range;

a reception unit configured to receive uplink data that the user equipment bears in an uplink temporal unit and transmits over the first frequency resource according to the resource schedule information; and

a transmission unit configured to bear downlink data in a downlink temporal unit and transmit the downlink data to the user equipment over a second frequency resource including a frequency resource in a downlink guard band and/or a frequency resource in the TDD frequency range, the downlink guard band being a guard band between an FDD downlink frequency range and the TDD frequency range

The invention provides a second method for utilizing guard bands, which includes:

receiving, by a first user equipment in a Time Division Duplex, TDD, system, downlink data that a first base station bears in a downlink temporal unit and transmits over a second frequency resource in a downlink guard band being a guard band between a Frequency Division Duplex, FDD, downlink frequency range and a TDD frequency range; and

bearing, by the first user equipment, uplink data in an uplink temporal unit and transmitting the uplink data to the first base station over a first frequency resource including a frequency resource in an uplink guard band and/or a frequency resource in the TDD frequency range, the uplink guard band being a guard band between an FDD uplink frequency range and the TDD frequency range

Correspondingly, the invention provides a user equipment including:

a reception unit configured to receive downlink data that a base station bears in a downlink temporal unit and transmits over a second frequency resource in a downlink guard band being a guard band between a Frequency Division Duplex, FDD, downlink frequency range and a Time Division Duplex, TDD, frequency range; and

a transmission unit configured to bear uplink data in an uplink temporal unit and transmit the uplink data to the base station over a first frequency resource including a frequency resource in an uplink guard band and/or a frequency resource in the TDD frequency range, the uplink guard band being a guard band between an FDD uplink frequency range and the TDD frequency range.

The invention provides a third method for utilizing guard bands, which includes:

allocating, by a first base station in a Frequency Division Duplex, FDD, system, a first frequency resource in an uplink guard band to a first user equipment and issuing resource schedule information, the uplink guard band being a guard band between an FDD uplink frequency range and a Time Division Duplex, TDD, frequency range;

receiving, by the first base station, uplink data transmitted from the first user equipment over the first frequency resource according to the resource schedule information in a period of time aligned with an uplink temporal unit of a TDD system; and

transmitting, by the first base station, downlink data to the first user equipment over a second frequency resource including a frequency resource in a downlink guard band corresponding to the first frequency resource and/or a frequency resource in an FDD downlink frequency range, the downlink guard band being a guard band between the FDD downlink frequency range and the TDD frequency range

Correspondingly, the invention provides a base station including:

a resource scheduling unit configured to allocate a first frequency resource in an uplink guard band to a user equipment and issue resource schedule information, the uplink guard band being a guard band between a Frequency Division Duplex, FDD, uplink frequency range and a Time Division Duplex, TDD, frequency range;

a reception unit configured to receive uplink data transmitted from the user equipment over the first frequency resource in a period of time aligned with an uplink temporal unit of a TDD system; and

a transmission unit configured to transmit downlink data to the user equipment over a second frequency resource including a frequency resource in a downlink guard band corresponding to the first frequency resource and/or a frequency resource in an FDD downlink frequency range, the downlink guard band being a guard band between the FDD downlink frequency range and the TDD frequency range.

The invention provides a fourth method for utilizing guard bands, which includes:

receiving, by a first user equipment in a Frequency Division Duplex, FDD, system, downlink data transmitted from a first base station over a second frequency resource in a downlink guard band in a period of time aligned with a downlink temporal unit of a Time Division Duplex, TDD, system, the downlink guard band being a guard band between an FDD downlink frequency range and a TDD frequency range; and

transmitting, by the first user equipment, uplink data to the first base station over a first frequency resource including a frequency resource in an uplink guard band corresponding to the second frequency resource and/or a frequency resource in an FDD uplink frequency range, the uplink guard band being a guard band between the FDD uplink frequency range and the TDD frequency range.

Correspondingly, the invention provides a user equipment including:

a reception unit configured to receive downlink data transmitted from a base station over a second frequency resource in a downlink guard band in a period of time aligned with a downlink temporal unit of a Time Division Duplex, TDD, system, the downlink guard band being a guard band between a Frequency Division Duplex, FDD, downlink frequency range and a TDD frequency range; and

a transmission unit configured to transmit uplink data to the base station over a first frequency resource including a frequency resource in an uplink guard band corresponding to the second frequency resource and/or a frequency resource in an FDD uplink frequency range, the uplink guard band being a guard band between the FDD uplink frequency range and the TDD frequency range.

The invention provides a fifth method for utilizing guard bands, which includes:

transmitting, by a base station, downlink data to at least one user equipment in a period of time aligned with a downlink temporal unit of a Time Division Duplex, TDD, system over a frequency resource in a downlink guard band, the downlink guard band being a guard band between a Frequency Division Duplex, FDD, downlink frequency range and a TDD frequency range; and

receiving, by the respective user equipments, the downlink data transmitted from the base station in the period of time aligned with the downlink temporal unit over the frequency resource in the downlink guard band.

In the first method for utilizing guard bands according to the invention, the guard band between the FDD uplink frequency range and the TDD frequency range, i.e., the uplink guard band, is allocated to the TDD system for use, and only uplink data is transmitted over the frequency resource in the uplink guard band, thus satisfying required suppressing of adjacent channel interference upon coexistence of the TDD system and the FDD system and also effectively utilizing the frequency resource in the uplink guard band and improving the utilization ratio of the frequency spectrum resources for mobile communication.

In the second method for utilizing guard bands according to the invention, the guard band between the FDD downlink frequency range and the TDD frequency range, i.e., the downlink guard band, is allocated to the TDD system for use, and only downlink data is transmitted over the frequency resource in the downlink guard band, thus satisfying required suppressing of adjacent channel interference upon coexistence of the TDD system and the FDD system and also effectively utilizing the frequency resource in the downlink guard band and improving the utilization ratio of the frequency spectrum resources for mobile communication.

In the third method for utilizing guard bands according to the invention, the guard band between the FDD uplink frequency range and the TDD frequency range, i.e., the uplink guard band, is allocated to the TDD system for use, and uplink data is transmitted only in a period of time aligned with an uplink temporal unit of the TDD system over the frequency resource in the uplink guard band, thus satisfying required suppressing of adjacent channel interference upon coexistence of the TDD system and the FDD system and also effectively utilizing the frequency resource in the uplink guard band and improving the utilization ratio of the frequency spectrum resources for mobile communication.

In the fourth method for utilizing guard bands according to the invention, the guard band between the FDD downlink frequency range and the TDD frequency range, i.e., the downlink guard band, is allocated to the TDD system for use, and downlink data is transmitted only in a period of time aligned with an downlink temporal unit of the TDD system over the frequency resource in the downlink guard band, thus satisfying required suppressing adjacent channel interference upon coexistence of the TDD system and the FDD system and also effectively utilizing the frequency resource in the downlink guard band and improving the utilization ratio of the frequency spectrum resources for mobile communication.

In the fifth method for utilizing guard bands according to the invention, the guard band between the FDD downlink frequency range and the TDD frequency range, i.e., the downlink guard band, is used for system broadcasting, and downlink data is transmitted to a plurality of user equipments over the frequency resource in the downlink guard band only in a period of time aligned with an downlink temporal unit of the TDD system, thus satisfying required suppressing adjacent channel interference upon coexistence of the TDD system and the FDD system and also effectively utilizing the frequency resource in the downlink guard band and improving the utilization ratio of the frequency spectrum resources for mobile communication.

### BRIEF DESCRIPTION OF THE DRAWINGS

FIG. 1 is a schematic diagram of guard bands in the prior art;

FIG. 2 is a schematic diagram of an implementation principle of embodiments of the invention;

FIG. 3 illustrates a flow chart of data transmission in a TDD system according to a first embodiment of the invention;

FIG. 4 illustrates a flow chart of data transmission in a TDD system according to a second embodiment of the invention;

FIG. 5 illustrates a flow chart of data transmission in an FDD system according to the second embodiment of the invention;

FIG. 6 illustrates a flow chart of data transmission in an FDD system according to a third embodiment of the invention;

FIG. 7 illustrates a flow chart of data transmission in an FDD system according to a fourth embodiment of the invention;

FIG. 8 illustrates a flow chart of data transmission in a TDD system according to the fourth embodiment of the invention;

FIG. 9 illustrates a flow chart of data transmission for system broadcasting in a Zone C according to a fifth embodiment of the invention;

FIG. 10 illustrates a flow chart of a first method for utilizing guard bands according to an embodiment of the invention;

FIG. 11 illustrates a structural block diagram of a base station in a TDD system according to an embodiment of the invention;

FIG. 12 illustrates a flow chart of a second method for utilizing guard bands according to an embodiment of the invention;

FIG. 13 illustrates a structural block diagram of a user equipment in a TDD system according to an embodiment of the invention;

FIG. 14 illustrates a flow chart of a third method for utilizing guard bands according to an embodiment of the invention;

FIG. 15 illustrates a structural block diagram of a base station in an FDD system according to an embodiment of the invention;

FIG. 16 illustrates a flow chart of a fourth method for utilizing guard bands according to an embodiment of the invention; and

FIG. 17 illustrates a structural block diagram of a user equipment in an FDD system according to an embodiment of the invention.

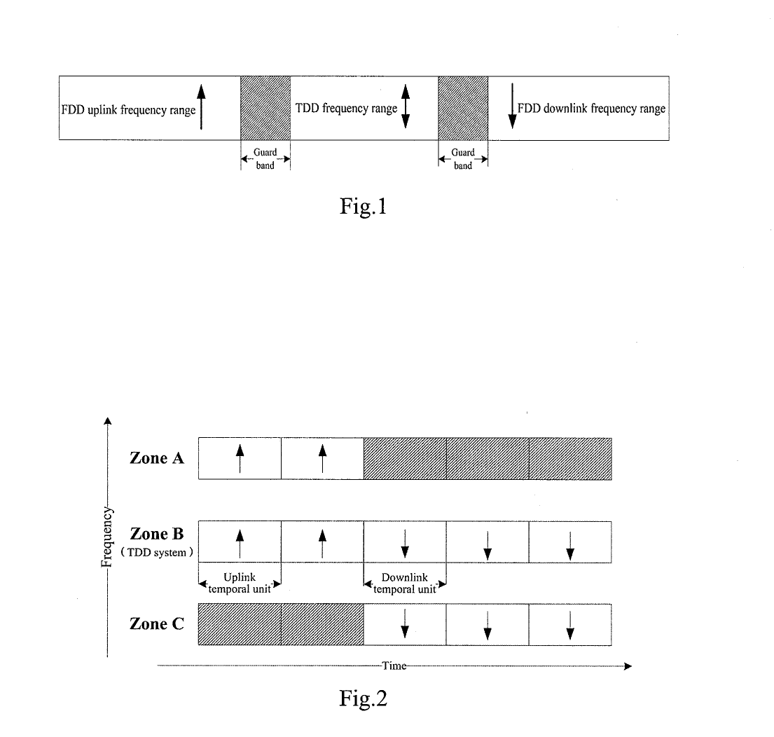

### DETAILED DESCRIPTION OF THE EMBODIMENTS

In view of the problem in the prior art of a serious waste of frequency resources and a low utilization ratio of the frequency spectrum resources for mobile communication due to reservation of guard bands for suppressing adjacent channel interference upon coexistence of a TDD system and an FDD system, embodiments of the invention provide a method for utilizing guard bands to effectively utilize frequency resources in the guard bands while suppressing adjacent channel interference upon coexistence of the TDD system and the FDD system to thereby improve the utilization ratio of the frequency spectrum resources for mobile communication.

First of all, an implementation principle of the embodiments of the invention is introduced.

Since two separate symmetric frequency ranges including an FDD uplink frequency range for transmission of uplink data and an FDD downlink frequency range for transmission of downlink data are used in an FDD system, two separate symmetric guard bands are reserved between frequency ranges of a TDD system and the FDD system in the prior art. The guard band between the FDD uplink frequency range and a TDD frequency range may be referred to as an uplink guard band represented as a Zone A, which is reserved generally for the purpose of suppressing interference of the TDD downlink to the FDD uplink, while interference of the TDD uplink to the FDD uplink and interference of the FDD uplink to the TDD uplink in the Zone A can satisfy a generally required Adjacent Channel Interference Ratio (ACIR) index; and the guard band between the FDD downlink frequency range and the TDD frequency range may be referred to as a downlink guard band represented as a Zone C, which is reserved generally for the purpose of suppressing interference of the TDD uplink to the FDD downlink, while interference of the TDD downlink to the FDD downlink and interference of the FDD downlink to the TDD downlink in the Zone C can satisfy the generally required Adjacent Channel Interference Ratio (ACIR) index. For a convenient description, the TDD frequency range is represented as a Zone B in the embodiments of the invention.

Following the foregoing analysis, an implementation principle of the embodiments of the invention is as illustrated in FIG. 2, and in view of allocated temporal units of the TDD system, if the Zone A is used only for transmission of uplink data, the Zone C is used only for transmission of downlink data and periods of time for transmission of the uplink and downlink data are aligned with the uplink and downlink temporal units of the TDD system, for the Zone A, interference between the TDD uplink and the FDD uplink can satisfy the generally required ACIR index, and for the Zone C, interference between the TDD downlink and the FDD downlink can satisfy the generally required ACIR index, thereby achieving the purpose of suppressing adjacent channel interference upon coexistence of the TDD and FDD systems. In the embodiments of the invention, the temporal units of the TDD system include time slots and OFDM symbols.

In light of the foregoing implementation principle, the embodiments of the invention provide a method for utilizing guard bands in several application scenarios, for example, both the Zone A and the Zone C are allocated to the TDD system for use in a first application scenario; the Zone A is allocated to the TDD system for use and the Zone C is allocated to the FDD system for use in a second application scenario; both the Zone A and the Zone C are allocated to the FDD system for use in a third application scenario; the Zone A is allocated to the FDD system for use and the Zone C is allocated to the TDD system for use in a fourth application scenario; and the Zone C is used separately for system broadcasting in a fifth application scenario. Of course, other application scenarios are also possible, for example, the Zone A is allocated to the TDD system for use, and as in the prior art, the Zone C is still disallowed for use, or the Zone C is allocated to the FDD system for use, and as in the prior art, the Zone A is still disallowed for use, etc., and they are omitted here.

A method for utilizing guard bands according to the embodiments of the invention is detailed below in connection with various application scenarios.

### A First Embodiment

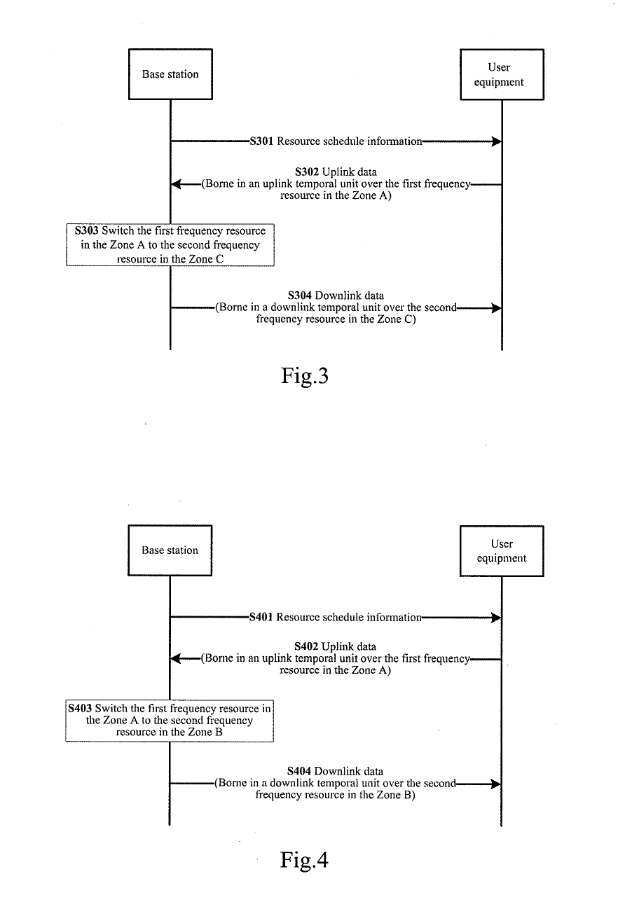

The first embodiment is directed to the first application scenario in which the Zone A, the Zone B and the Zone C are used in the TDD system, where the Zone A and the Zone C may be used in pair. A base station and a user equipment in the TDD system transmit data over frequency resources in the Zone A and the Zone C in a process as illustrated in FIG. 3, which includes the following steps.

S301. The base station allocates the frequency resource in the Zone A (referred to as a first frequency resource for convenient differentiation) to the user equipment and issues resource schedule information.

S302. The user equipment bears uplink data in an uplink temporal unit and transmits the uplink data to the base station over the first frequency resource in the Zone A according to the resource schedule information, and correspondingly, the base station receives the uplink data that the user equipment bears in the uplink temporal unit and transmits over the first frequency resource in the Zone A.

S303. The base station switches the first frequency resource in the Zone A to the frequency resource in the Zone C (referred to as a second frequency resource for convenient differentiation).

S304. The base station bears downlink data in a downlink temporal unit and transmits the downlink data to the user equipment over the second frequency resource in the Zone C, and correspondingly, the user equipment receives the downlink data that the base station bears in the downlink temporal unit and transmits over the second frequency resource in the Zone C.

Subsequently, the user equipment may switch the second frequency resource in the Zone C to the first frequency source in the Zone A, bear uplink data in an uplink temporal unit and transmit the uplink data to the base station over the first frequency resource in the Zone A, thereby making use of the frequency resources in the Zone A and the Zone C in pair through frequency switching to repeat the foregoing data transmission process. It shall be noted that in the present embodiment, the Zone A and the Zone B may be scheduled jointly and the Zone B and the Zone C may be scheduled jointly, and the user equipment may transmit uplink data to the base station concurrently over the frequency resources in the Zone A and the Zone B and also the base station may transmit downlink data to the user equipment concurrently over the frequency resources in the Zone B and the Zone C.

### A Second Embodiment

The second embodiment is directed to the second application scenario in which the Zone A and the Zone B are used in the TDD system and the Zone C, the FDD uplink frequency range and the FDD downlink frequency range are used in the FDD system. A base station and a user equipment in the TDD system transmit data over frequency resources in the Zone A and the Zone B in a process as illustrated in FIG. 4, which includes the following steps.

S401. The base station allocates the frequency resource in the Zone A (referred to as a first frequency resource for convenient differentiation) to the user equipment and issues resource schedule information.

S402. The user equipment bears uplink data in an uplink temporal unit and transmits the uplink data to the base station over the first frequency resource in the Zone A according to the resource schedule information, and correspondingly, the base station receives the uplink data that the user equipment bears in the uplink temporal unit and transmits over the first frequency resource in the Zone A.

S403. The base station switches the first frequency resource in the Zone A to the frequency resource in the Zone B (referred to as a second frequency resource for convenient differentiation).

S404. The base station bears downlink data in a downlink temporal unit and transmits the downlink data to the user equipment over the second frequency resource in the Zone B, and correspondingly, the user equipment receives the downlink data that the base station bears in the downlink temporal unit and transmits over the second frequency resource in the Zone B.

Subsequently, the user equipment may switch the second frequency resource in the Zone B to the first frequency source in the Zone A, bear uplink data in an uplink temporal unit and transmit the uplink data to the base station over the first frequency resource in the Zone A, alternatively may bear the uplink data in an uplink temporal unit and transmit the uplink data to the base station directly over the second frequency resource in the Zone B without frequency switching.

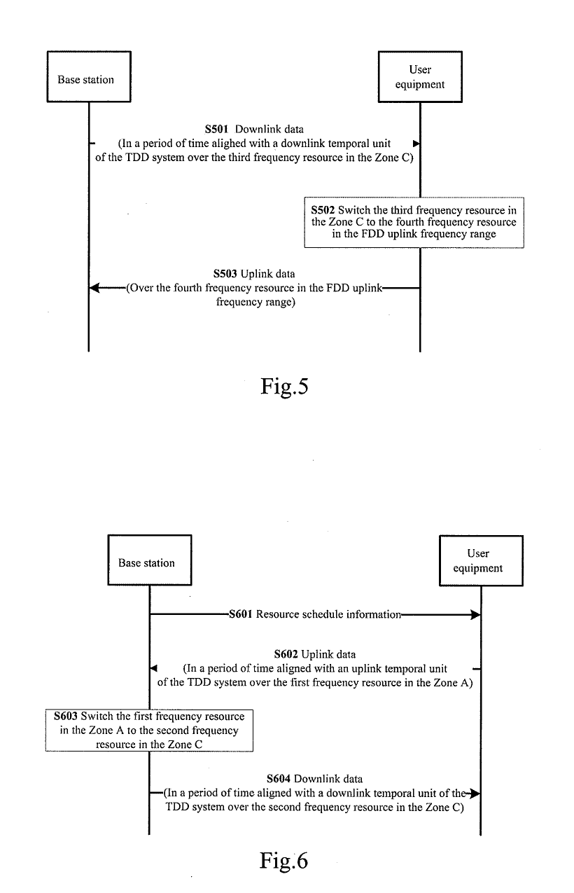

A base station and a user equipment in the FDD system transmit data over frequency resources in the Zone C, the FDD uplink frequency range and the FDD downlink frequency range in a process as illustrated in FIG. 5, which includes the following steps.

S501. The base station transmits downlink data to the user equipment over the frequency resource in the Zone C (referred to as a third frequency resource for convenient differentiation) in a period of time aligned with a downlink temporal unit of the TDD system, and correspondingly, the user equipment receives the downlink data transmitted from the base station over the third frequency resource in the Zone C.

S502. The user equipment switches the third frequency resource in the Zone C to the frequency resource in the FDD uplink frequency range (referred to as a fourth frequency resource for convenient differentiation).

S503. The user equipment transmits uplink data to the base station over the fourth frequency resource in the FDD uplink frequency range, and correspondingly, the base station receives the uplink data transmitted from the user equipment over the fourth frequency resource in the FDD uplink frequency range.

Subsequently, the base station may switch the fourth frequency resource in the FDD uplink frequency range to the third frequency resource in the Zone C and transmit downlink data to the user equipment over the third frequency resource in the Zone C in a period of time aligned with a downlink temporal unit of the TDD system, alternatively may switch the fourth frequency resource in the FDD uplink frequency range to the corresponding frequency resource in the FDD downlink frequency range and transmit downlink data to the user equipment over the frequency resource in the FDD downlink frequency range.

### A Third Embodiment

The third embodiment is directed to the third application scenario in which the Zone A, the Zone C, the FDD uplink frequency range and the FDD downlink frequency range are used in the FDD system, where the Zone A and the Zone C may be used in pair. A base station and a user equipment in the FDD system transmit data over frequency resources in the Zone A and the Zone C in a process as illustrated in FIG. 6, which includes the following steps.

S601. The base station allocates the frequency resource in the Zone A (referred to as a first frequency resource for convenient differentiation) to the user equipment and issues resource schedule information.

S602. The user equipment transmits uplink data to the base station over the first frequency resource in the Zone A in a period of time aligned with an uplink temporal unit of the TDD system according to the resource schedule information, and correspondingly, the base station receives the uplink data transmitted from the user equipment over the first frequency resource in the Zone A.

S603. The base station switches the first frequency resource in the Zone A to the frequency resource in the Zone C corresponding to the first frequency resource (referred to as a second frequency resource for convenient differentiation).

S604. The base station transmits downlink data to the user equipment over the second frequency resource in the Zone C in a period of time aligned with a downlink temporal unit of the TDD system, and correspondingly, the user equipment receives the downlink data transmitted from the base station over the second frequency resource in the Zone C.

Subsequently, the user equipment may switch the second frequency resource in the Zone C to the first frequency resource in the Zone A and transmit uplink data to the base station over the first frequency resource in the Zone A in a period of time aligned with an uplink temporal unit of the TDD system, thereby making use of the corresponding frequency resources in the Zone A and the Zone C in pair through frequency switching to repeat the foregoing data transmission process. It shall be noted that in the present embodiment, the Zone A and the FDD uplink frequency range may be scheduled jointly and the Zone C and the FDD downlink frequency range may be scheduled jointly, and the user equipment may transmit uplink data concurrently over the frequency resources in the Zone A and the FDD uplink frequency range and also the base station may transmit downlink data concurrently over the frequency resources in the FDD downlink frequency range and the Zone C.

### A Fourth Embodiment

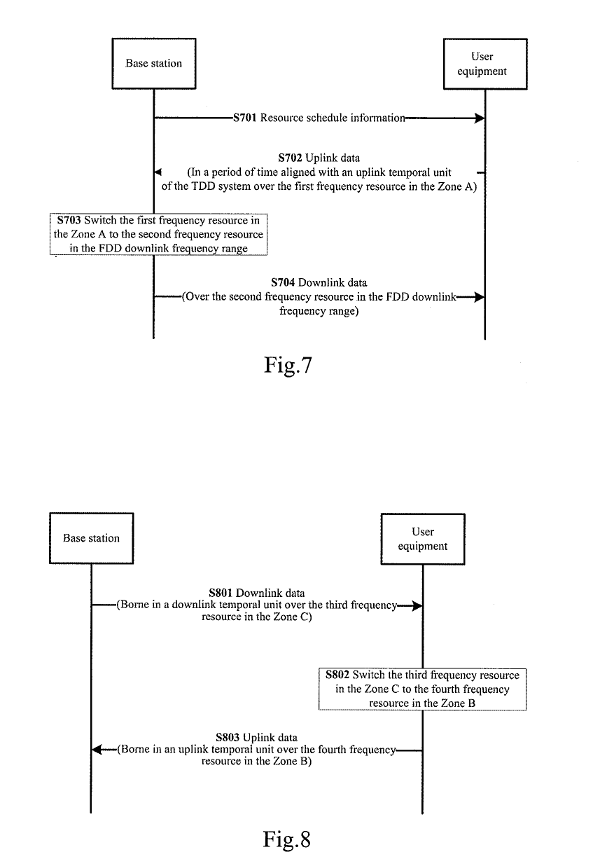

The fourth embodiment is directed to the fourth application scenario in which the Zone A, the FDD uplink frequency range and the FDD downlink frequency range are used in the FDD system and the Zone B and the Zone C are used in the TDD system. A base station and a user equipment in the FDD system transmit data over frequency resources in the Zone A, the FDD uplink frequency range and the FDD downlink frequency range in a process as illustrated in FIG. 7, which includes the following steps.

S701. The base station allocates the frequency resource in the Zone A (referred to as a first frequency resource for convenient differentiation) to the user equipment and issues resource schedule information.

S702. The user equipment transmits uplink data to the base station over the first frequency resource in the Zone A in a period of time aligned with an uplink temporal unit of the TDD system according to the resource schedule information, and correspondingly, the base station receives the uplink data transmitted from the user equipment over the first frequency resource in the Zone A.

S703. The base station switches the first frequency resource in the Zone A to the frequency resource in the FDD downlink frequency range (referred to as a second frequency resource for convenient differentiation).

S704. The base station transmits downlink data to the user equipment over the second frequency resource in the FDD downlink frequency range, and correspondingly, the user equipment receives the downlink data transmitted from the base station over the second frequency resource in the FDD downlink frequency range.

Subsequently, the user equipment may switch the second frequency resource in the FDD downlink frequency range to the first frequency resource in the Zone A and transmit uplink data to the base station over the first frequency resource in the Zone A in a period of time aligned with an uplink temporal unit of the TDD system, alternatively may switch the second frequency resource in the FDD downlink frequency range to the corresponding frequency resource in the FDD uplink frequency range and transmit uplink data to the base station over the frequency resource in the FDD uplink frequency range.

A base station and a user equipment in the TDD system transmit data over frequency resources in the Zone B and the Zone C in a process as illustrated in FIG. 8, which includes the following steps.

S801. The base station bears downlink data in a downlink temporal unit and transmits the downlink data to the user equipment over the frequency resource in the Zone C (referred to as a third frequency resource for convenient differentiation), and correspondingly, the user equipment receives the downlink data transmitted from the base station over the third frequency resource in the Zone C.

S802. The user equipment switches the third frequency resource in the Zone C to the frequency resource in the Zone B (referred to as a fourth frequency resource for convenient differentiation).

S803. The user equipment bears uplink data in an uplink temporal unit and transmits the uplink data to the base station over the fourth frequency resource in the Zone B, and correspondingly, the base station receives the uplink data transmitted from the user equipment over the fourth frequency resource in the Zone B.

Subsequently, the base station may switch the fourth frequency resource in the Zone B to the third frequency resource in the Zone C and bears downlink data in a downlink temporal unit and transmit the downlink data to the user equipment over the third frequency resource in the Zone C, alternatively may bear the downlink data in a downlink temporal unit and transmit the downlink data to the user equipment directly over the fourth frequency resource in the Zone B without frequency switching.

### A Fifth Embodiment

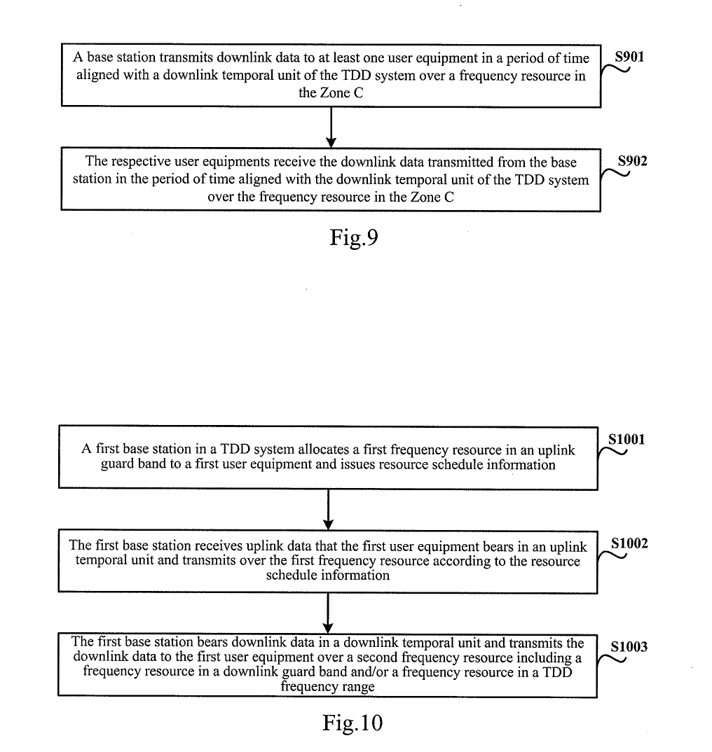

The fifth embodiment is directed to the fifth application scenario in which the Zone C is used separately for system broadcasting as illustrated in FIG. 9, for example, broadcasting of a mobile-phone television program to a user equipment in the Zone C, which includes the following steps.

S901. A base station transmits downlink data to at least one user equipment in a period of time aligned with a downlink temporal unit of the TDD system over a frequency resource in the Zone C.

S902. The respective user equipments receive the downlink data transmitted from the base station in the period of time aligned with the downlink temporal unit of the TDD system over the frequency resource in the Zone C.

Based upon the first embodiment and the second embodiment, an embodiment of the invention provides a method for utilizing guard bands, which as illustrated in FIG. 10 includes the following steps.

S1001. A first base station in a TDD system allocates a first frequency resource in an uplink guard band to a first user equipment and issues resource schedule information.

S1002. The first base station receives uplink data that the first user equipment bears in an uplink temporal unit and transmits over the first frequency resource according to the resource schedule information.

S1003. The first base station bears downlink data in a downlink temporal unit and transmits the downlink data to the first user equipment over a second frequency resource including a frequency resource in a downlink guard band and/or a frequency resource in a TDD frequency range.

In an embodiment, the second frequency resource is the frequency resource in the TDD frequency range, and the method may further include the following steps:

a second base station in an FDD system transmits downlink data to a second user equipment over a third frequency resource in the downlink guard band in a period of time aligned with a downlink temporal unit of the TDD system; and

the second user equipment switches the third frequency resource to a fourth frequency resource in an FDD uplink frequency range and transmits uplink data to the second base station over the fourth frequency resource.

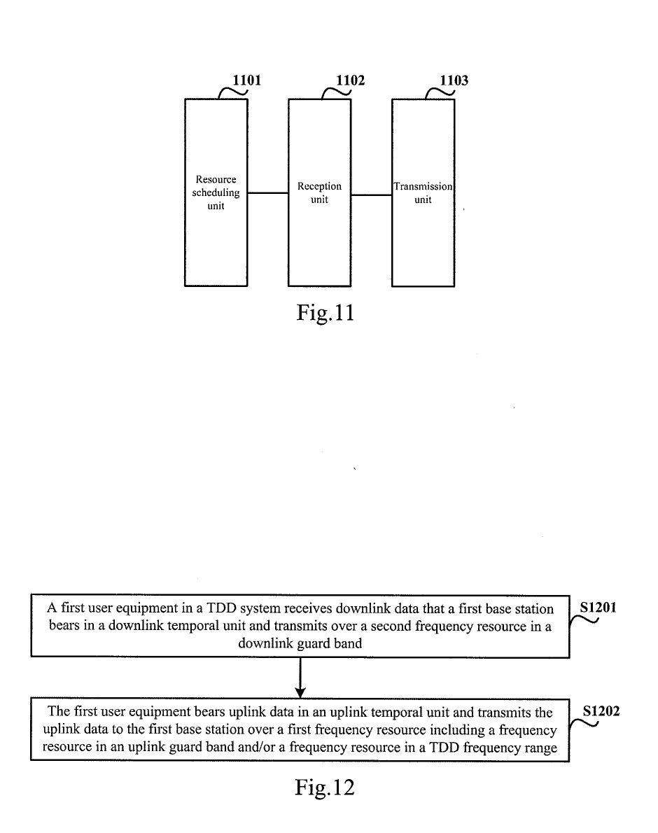

Based upon the same technical concept, an embodiment of the invention provides a base station in a TDD system, and as illustrated in FIG. 11, a possible structure of the base station includes a resource scheduling unit 1101, a reception unit 1102 and a transmission unit 1103.

The resource scheduling unit 1101 is configured to allocate a first frequency resource in an uplink guard band to a user equipment and issue resource schedule information.

The reception unit 1102 is configured to receive uplink data that the user equipment bears in an uplink temporal unit and transmits over the first frequency resource according to the resource schedule information.

The transmission unit 1103 is configured to bear downlink data in a downlink temporal unit and transmit the downlink data to the user equipment over a second frequency resource including a frequency resource in a downlink guard band and/or a frequency resource in a TDD frequency range.

Based upon the first embodiment and the fourth embodiment, an embodiment of the invention provides a method for utilizing guard bands, which as illustrated in FIG. 12 includes the following steps.

S1201. A first user equipment in a TDD system receives downlink data that a first base station bears in a downlink temporal unit and transmits over a second frequency resource in a downlink guard band.

S1202. The first user equipment bears uplink data in an uplink temporal unit and transmits the uplink data to the first base station over a first frequency resource including a frequency resource in an uplink guard band and/or a frequency resource in a TDD frequency range.

In an embodiment, the first frequency resource is the frequency resource in the TDD frequency range, and the method may further include the following steps:

a second user equipment in an FDD system transmits uplink data to a second base station over a third frequency resource in the uplink guard band in a period of time aligned with an uplink temporal unit of the TDD system;

the second base station switches the third frequency resource to a fourth frequency resource in an FDD downlink frequency range and transmits downlink data to the second user equipment over the fourth frequency resource.

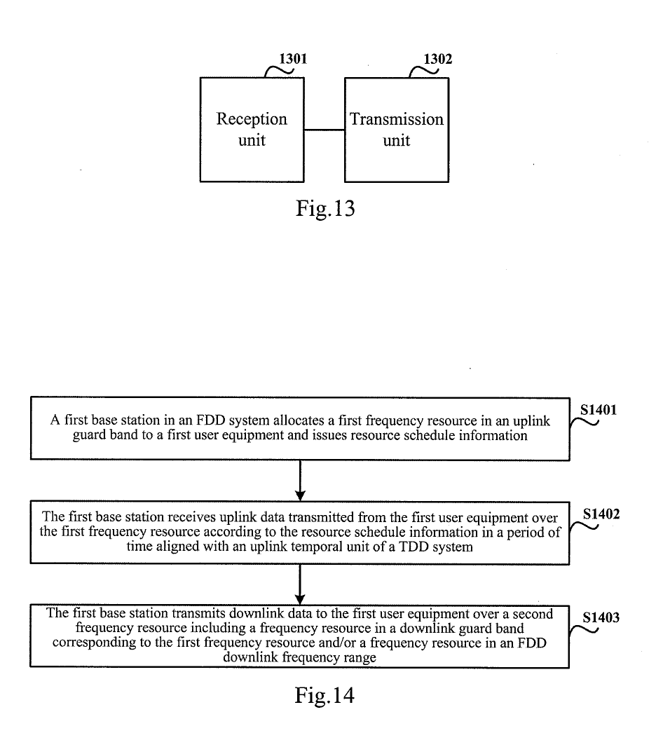

Based upon the same technical concept, an embodiment of the invention provides a user equipment in a TDD system, and as illustrated in FIG. 13, a possible structure of the user equipment includes a reception unit 1301 and a transmission unit 1302.

The reception unit 1301 is configured to receive downlink data that a base station bears in a downlink temporal unit and transmits over a second frequency resource in a downlink guard band.

The transmission unit 1302 is configured to bear uplink data in an uplink temporal unit and transmit the uplink data to the base station over a first frequency resource including a frequency resource in an uplink guard band and/or a frequency resource in a TDD frequency range.

Based upon the third embodiment and the fourth embodiment, an embodiment of the invention provides a method for utilizing guard bands, which as illustrated in FIG. 14 includes the following steps.

S1401. A first base station in an FDD system allocates a first frequency resource in an uplink guard band to a first user equipment and issues resource schedule information.

S1402. The first base station receives uplink data transmitted from the first user equipment over the first frequency resource according to the resource schedule information in a period of time aligned with an uplink temporal unit of a TDD system.

S1403. The first base station transmits downlink data to the first user equipment over a second frequency resource including a frequency resource in a downlink guard band corresponding to the first frequency resource and/or a frequency resource in an FDD downlink frequency range.

The downlink data is transmitted in a period of time aligned with a downlink temporal unit of the TDD system over the frequency resource in the downlink guard band corresponding to the first frequency resource.

In an embodiment, the second frequency resource is the frequency resource in the FDD downlink frequency range, and the method may further include the following steps:

a second base station in the TDD system bears downlink data in a downlink temporal unit and transmits the downlink data to a second user equipment over a third frequency resource in the downlink guard band; and

the second user equipment switches the third frequency resource to a fourth frequency resource in a TDD frequency range and bears uplink data in an uplink temporal unit and transmits the uplink data to the second base station over the fourth frequency resource.

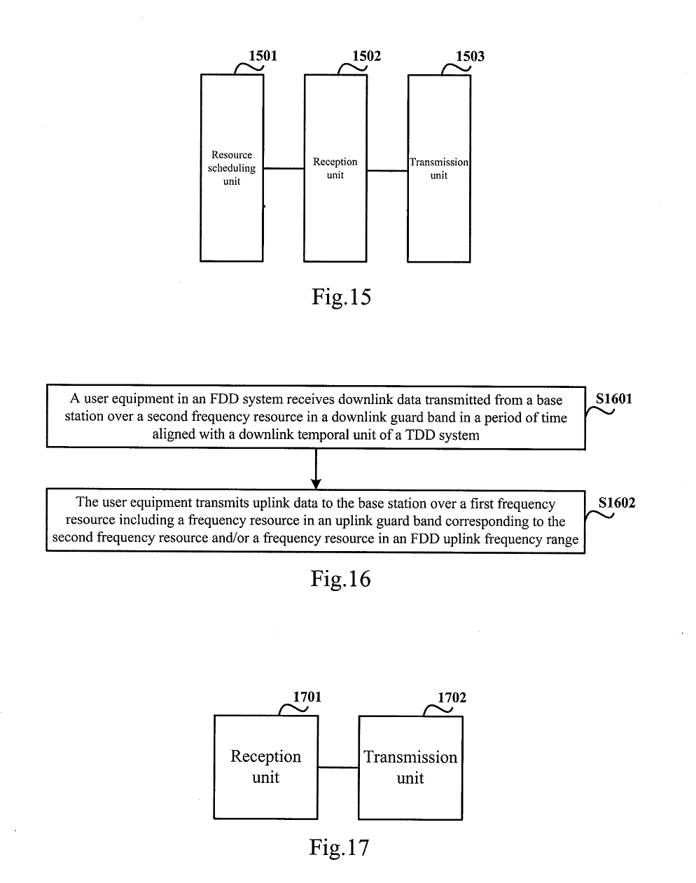

Based upon the same technical concept, an embodiment of the invention provides a base station in an FDD system, and as illustrated in FIG. 15, a possible structure of the base station includes a resource scheduling unit 1501, a reception unit 1502 and a transmission unit 1503.

The resource scheduling unit 1501 is configured to allocate a first frequency resource in an uplink guard band to a user equipment and issue resource schedule information.

The reception unit 1502 is configured to receive uplink data transmitted from the user equipment over the first frequency resource in the uplink guard band in a period of time aligned with an uplink temporal unit of a TDD system.

The transmission unit 1503 is configured to transmit downlink data to the user equipment over a second frequency resource including a frequency resource in a downlink guard band corresponding to the first frequency resource and/or a frequency resource in an FDD downlink frequency range.

Based upon the second embodiment and the third embodiment, an embodiment of the invention provides a method for utilizing guard bands, which as illustrated in FIG. 16 includes the following steps.

S1601. A user equipment in an FDD system receives downlink data transmitted from a base station over a second frequency resource in a downlink guard band in a period of time aligned with a downlink temporal unit of a TDD system.

S1602. The user equipment transmits uplink data to the base station over a first frequency resource including a frequency resource in an uplink guard band corresponding to the second frequency resource and/or a frequency resource in an FDD uplink frequency range.

The uplink data is transmitted in a period of time aligned with an uplink temporal unit of the TDD system over the frequency resource in the uplink guard band corresponding to the second frequency resource.

In an embodiment, the first frequency resource is the frequency resource in the FDD uplink frequency range, and the method may further include the following steps:

a second user equipment in the TDD system bears uplink data in an uplink temporal unit and transmits the uplink data to a second base station over a third frequency resource in the uplink guard band; and

the second base station switches the third frequency resource to a fourth frequency resource in a TDD frequency range and bears downlink data in a downlink temporal unit and transmits the downlink data to the second user equipment over the fourth frequency resource.

Based upon the same technical concept, an embodiment of the invention provides a user equipment in an FDD system, and as illustrated in FIG. 17, a possible structure of the user equipment includes a reception unit 1701 and a transmission unit 1702.

The reception unit 1701 is configured to receive downlink data transmitted from a base station over a second frequency resource in a downlink guard band in a period of time aligned with a downlink temporal unit of a TDD system.

The transmission unit 1702 is configured to transmit uplink data to the base station over a first frequency resource including a frequency resource in an uplink guard band corresponding to the second frequency resource and/or a frequency resource in an FDD uplink frequency range.

In the method for utilizing guard bands according to the embodiments of the invention, when a TDD system and an FDD system coexist, an uplink guard band or a downlink guard band may be allocated respectively to the TDD system or the FDD system for use, or both the uplink and downlink guard bands may be allocated to the TDD system or the FDD system for use, or the downlink guard band may be used separately for system broadcasting; and only uplink data can be transmitted over a frequency resource in the uplink guard band and only downlink data can be transmitted over a frequency resource in the downlink guard band, and periods of time in which the uplink and downlink data is transmitted may be aligned with uplink and downlink temporal units of the TDD system, thus satisfying required suppressing of adjacent channel interference upon coexistence of the TDD system and the FDD system and also effectively utilizing the frequency resources in the guard bands and improving the utilization ratio of the frequency spectrum resources for mobile communication.

It will be appreciated that one skilled in the art may make various modifications and alterations to the present invention without departing from the scope of the present invention. Accordingly, if these modifications and alterations to the present invention fall within the scope of the claims of the present invention and their equivalents, the present invention intends to include all these modifications and alterations.

1-15. (canceled)

16. A method for utilizing guard bands, comprising:
allocating, by a base station, a first frequency resource in an uplink guard band to a user equipment and issuing resource schedule information, the uplink guard band being a guard band between a Frequency Division Duplex, FDD, uplink frequency range and a Time Division Duplex, TDD, frequency range;
receiving, by the base station, uplink data that the user equipment transmits over the first frequency resource according to the resource schedule information; and
transmitting, by the base station, downlink data to the user equipment over a second frequency resource comprising a frequency resource in a downlink guard band and a frequency resource in a frequency range in a corresponding duplex mode adjacent to the downlink guard band, the downlink guard band being a guard band between an FDD downlink frequency range and the TDD frequency range.

17. The method according to claim 16, wherein the base station is a base station in a TDD system, the frequency resource in a frequency range in a corresponding duplex mode adjacent to the downlink guard band is a frequency resource in the TDD frequency range;
receiving by the base station uplink data that the user equipment transmits over the first frequency resource according to the resource schedule information comprises: receiving, by the base station, the uplink data that the user equipment bears in an uplink temporal unit of the TDD system and transmits over the first frequency resource according to the resource schedule information; and
transmitting by the base station downlink data to the user equipment over a second frequency resource comprises: bearing, by the base station, the downlink data in a downlink temporal unit of the TDD system and transmitting the downlink data to the user equipment over the second frequency resource.

18. The method according to claim 16, wherein the base station is a base station in a FDD system, the frequency resource in the downlink guard band is a frequency resource in the downlink guard band corresponding to the first frequency resource, and the frequency resource in a frequency range in a corresponding duplex mode adjacent to the downlink guard band is a frequency resource in the FDD downlink frequency range; and
receiving by the base station uplink data that the user equipment transmits over the first frequency resource according to the resource schedule information comprises: receiving, by the base station, the uplink data transmitted from the user equipment over the first frequency resource according to the resource schedule information in a period of time aligned with an uplink temporal unit of a TDD system.

19. The method according to claim 18, wherein transmitting by the base station downlink data to the user equipment over a second frequency resource comprises:
transmitting, by the base station, the downlink data in a period of time aligned with a downlink temporal unit of the TDD system over the frequency resource in the downlink guard band corresponding to the first frequency resource.

20. A base station, comprising:
a resource scheduling unit configured to allocate a first frequency resource in an uplink guard band to a user equipment and issue resource schedule information, the uplink guard band being a guard band between a Frequency Division Duplex, FDD, uplink frequency range and a Time Division Duplex, TDD, frequency range;
a reception unit configured to receive uplink data that the user equipment transmits over the first frequency resource according to the resource schedule information; and
a transmission unit configured to transmit downlink data to the user equipment over a second frequency resource comprising a frequency resource in a downlink guard band and a frequency resource in a frequency range in a corresponding duplex mode adjacent to the downlink guard band, the downlink guard band being a guard band between an FDD downlink frequency range and the TDD frequency range.

21. The base station according to claim 20, wherein the frequency resource in a frequency range in a corresponding duplex mode adjacent to the downlink guard band is a frequency resource in the TDD frequency range;
the reception unit is further configured to receive the uplink data that the user equipment bears in an uplink temporal unit of a TDD system and transmits over the first frequency resource according to the resource schedule information; and
the transmission unit is further configured to bear the downlink data in a downlink temporal unit of the TDD system and transmitting the downlink data to the user equipment over the second frequency resource.

22. The base station according to claim 20, wherein the frequency resource in the downlink guard band is a frequency resource in the downlink guard band corresponding to the first frequency resource, and the frequency resource in a frequency range in a corresponding duplex mode adjacent to the downlink guard band is a frequency resource in the FDD downlink frequency range; and
the reception unit is further configured to receive the uplink data transmitted from the user equipment over the first frequency resource according to the resource schedule information in a period of time aligned with an uplink temporal unit of a TDD system.

23. A method for utilizing guard bands, comprising:
receiving, by a user equipment, downlink data that a base station transmits over a second frequency resource in a downlink guard band being a guard band between a Frequency Division Duplex, FDD, downlink frequency range and a Time Division Duplex, TDD, frequency range; and
transmitting, by the user equipment, uplink data to the base station over a first frequency resource comprising a frequency resource in an uplink guard band and a frequency resource in a frequency range in a corresponding duplex mode adjacent to the uplink guard band, the uplink guard band being a guard band between an FDD uplink frequency range and the TDD frequency range.

24. The method according to claim 23, wherein the user equipment is a user equipment in a TDD system, the frequency resource in a frequency range in a corresponding duplex mode adjacent to the uplink guard band is a frequency resource in the TDD frequency range;
receiving by the user equipment downlink data that a base station transmits over a second frequency resource in a downlink guard band comprises: receiving, by the user equipment, the downlink data that the base station bears in a downlink temporal unit of the TDD system and transmits over the second frequency resource in the downlink guard band; and
transmitting by the user equipment uplink data to the base station over a first frequency resource comprises: bearing, by the user equipment, the uplink data in an uplink temporal unit of the TDD system and transmitting the uplink data to the base station over the first frequency resource.

25. The method according to claim 23, wherein the user equipment is a user equipment in a FDD system, the frequency resource in the uplink guard band is a frequency resource in the uplink guard band corresponding to the second frequency resource, and the frequency resource in a frequency range in a corresponding duplex mode adjacent to the uplink guard band is a frequency resource in the FDD uplink frequency range; and
receiving by the user equipment downlink data that a base station transmits over a second frequency resource in a downlink guard band comprises: receiving, by the user equipment, the downlink data transmitted from the base station over the second frequency resource in the downlink guard band in a period of time aligned with a downlink temporal unit of a TDD system.

26. The method according to claim 25, transmitting by the user equipment uplink data to the base station over a first frequency resource comprises:
transmitting, by the user equipment, the uplink data in a period of time aligned with an uplink temporal unit of the TDD system over the frequency resource in the uplink guard band corresponding to the second frequency resource.

27. A user equipment, comprising:
a reception unit configured to receive downlink data transmitted from a base station over a second frequency resource in a downlink guard band, the downlink guard band being a guard band between a Frequency Division Duplex, FDD, downlink frequency range and a Time Division Duplex, TDD, frequency range; and
a transmission unit configured to transmit uplink data to the base station over a first frequency resource comprising a frequency resource in an uplink guard band and a frequency resource in a frequency range in a corresponding duplex mode adjacent to the uplink guard band, the uplink guard band being a guard band between an FDD uplink frequency range and the TDD frequency range.

28. The user equipment according to claim 27, wherein the frequency resource in a frequency range in a corresponding duplex mode adjacent to the uplink guard band is a frequency resource in the TDD frequency range;
the reception unit is further configured to receive the downlink data that the base station bears in a downlink temporal unit of a TDD system and transmits over the second frequency resource in the downlink guard band; and
the transmission unit is further configured to bear the uplink data in an uplink temporal unit of the TDD system and transmit the uplink data to the base station over the first frequency resource.

29. The user equipment according to claim 27, wherein the frequency resource in the uplink guard band is a frequency resource in the uplink guard band corresponding to the second frequency resource, and the frequency resource in a frequency range in a corresponding duplex mode adjacent to the uplink guard band is a frequency resource in the FDD uplink frequency range; and
the reception unit is further configured to receive the downlink data transmitted from the base station over the second frequency resource in the downlink guard band in a period of time aligned with a downlink temporal unit of a TDD system.
